(19) United States
(12) Patent Application Publication
(10) Pub. No.: US 2015/0067581 A1
(43) Pub. Date: Mar. 5, 2015

(54) SYSTEM AND METHOD FOR A GRAPHICAL USER INTERFACE FOR HIERARCHICAL NAVIGATION

(71) Applicant: Kobo Incorporated, Toronto (CA)

(72) Inventors: James WU, Toronto (CA); Robin BENNETT, Toronto (CA); Shanak RAHMAN, Toronto (CA); Daniel HILL, Toronto (CA)

(73) Assignee: Kobo Incorporated, Toronto (CA)

(21) Appl. No.: 14/017,004

(22) Filed: Sep. 3, 2013

(51) Int. Cl. G06F 3/0485; G06F 3/0482; G06F 3/0484

(52) U.S. Cl. CPC G06F 3/0485; G06F 3/04845; G06F 3/0482
USPC 715/784; 715/810; 715/800

(57) ABSTRACT

A system and method for a graphical user interface operable for navigation of a multimedia container hierarchy. The method includes accessing, within a mobile device, a first data store corresponding to a first multimedia container. The first multimedia container is operable to comprise one or more applications, widgets, and pieces of content. The first multimedia container comprises a second multimedia container. The method further includes displaying a first image corresponding to the second multimedia container and receiving a first input. The method further includes displaying a second image corresponding to a third multimedia container. The second multimedia container comprises the third multimedia container.

### CROSS REFERENCE TO RELATED APPLICATIONS

This application claims the benefit of and priority to the copending provisional patent application, Ser. No. 61/667,077, Attorney Docket Number 21161-P42484US00, entitled “SYSTEM AND METHOD OF PROVIDING A USER INTERFACE ON A MOBILE DEVICE,” with filing date Sep. 5, 2012, and hereby incorporated by reference in its entirety.

This application claims the benefit of and priority to the copending non-provisional patent application Ser. No. 13/601,363, Attorney Docket Number KOBO-0001, entitled “SYSTEM AND METHOD FOR A MULTIMEDIA CONTAINER,” with filing date May 23, 2013, and hereby incorporated by reference in its entirety.

This application claims the benefit of and priority to the copending non-provisional patent application Ser. No. 13/601,426, Attorney Docket Number KOBO-0002, entitled “SYSTEM AND METHOD FOR MANAGING OBJECTS IN A MULTIMEDIA CONTAINER,” with filing date May 23, 2013, and hereby incorporated by reference in its entirety.

This application claims the benefit of and priority to the copending non-provisional patent application Ser. No. 13/601,465, Attorney Docket Number KOBO-0003, entitled “SYSTEM AND METHOD FOR DISPLAYING A MULTIMEDIA CONTAINER,” with filing date May 23, 2013, and hereby incorporated by reference in its entirety.

This application claims the benefit of and priority to the copending non-provisional patent application Ser. No. 13/601,468, Attorney Docket Number KOBO-0004, entitled “SYSTEM AND METHOD FOR A HOME MULTIMEDIA CONTAINER,” with filing date May 23, 2013, and hereby incorporated by reference in its entirety.

This application is related to non-provisional patent application Ser. No. 13/631,563, Attorney Docket Number KOBO-0005, entitled “SYSTEM AND METHOD FOR A GRAPHICAL USER INTERFACE INCLUDING RECOMMENDATIONS,” with filing date Jun. 28, 2013, and hereby incorporated by reference in its entirety.

### FIELD OF THE INVENTION

Embodiments of the present invention are generally related to graphical user interfaces that may be part of a mobile device operating system.

### BACKGROUND

As computing technology has advanced, computers have become smaller and more portable thereby bringing about powerful handheld devices capable of performing functions of more traditional computing technology. At the same time operating systems for handheld devices or mobile devices have been developed to better suit handheld devices. Such operating systems have conventionally been focused around applications. For example, upon turning on a handheld device, the user is presented with a fixed grid of icons representing applications that the user can choose from.

In such an application or “app centric” interface, a user navigates pages of applications icons in a linear manner. The user needs to navigate through each page until he or she reaches the page having the desired application icon. For example, in order for a user to access an application call “Mail,” the user scrolls past each of the application icon starting with the letters A through L. Similarly, for an application nested within a folder hierarchy, the user navigates through each folder of applications in the folder hierarchy until reaching the desired application.

### SUMMARY OF THE INVENTION

Accordingly, what is needed is a solution to allow efficient navigation of multimedia containers and the corresponding multimedia container hierarchy. Embodiments of the present invention allow user navigating through (e.g., up and down) multiple levels of a hierarchical structure of multimedia containers quickly and efficiently. Embodiments of the present invention further allow for the display of a visualization of the hierarchical structure created by the multimedia containers of a device. By displaying minimized views of multimedia containers of different hierarchical levels simultaneously with an open multimedia container, a user may thus display and access (e.g., random access) a desired multimedia container one or more levels away in the multimedia hierarchy without having to navigate individually through each multimedia container between an upper or lower level multimedia container and the desired multimedia container.

In one embodiment, the present invention is directed to a method for rendering a graphical user interface. The method includes accessing, within a mobile device, a first data store corresponding to a first multimedia container. The first multimedia container is operable to comprise one or more applications, widgets, and pieces of content. The first multimedia container comprises a second multimedia container. The method further includes displaying a first image corresponding to the second multimedia container and receiving a first input. The method further includes displaying a second image corresponding to a third multimedia container. The second multimedia container comprises the third multimedia container. The first image and the second image may be displayed simultaneously. In one embodiment, the first image and the second image are displayed in a hierarchical structure. The first image may include a third image corresponding to a first object of the second multimedia container. The method may further include scaling the first image in response to the first input. The method may further include receiving a second input and in response to the second input, displaying a first object of the second multimedia container. The method may further include displaying a third image corresponding to a first object of the first multimedia container.

In one embodiment, the present invention is directed to a method for rendering a graphical user interface. The method includes accessing a data store comprising a hierarchical ordering of multimedia containers comprising a first level, a second level and a third level of the hierarchical ordering. Each multimedia container is operable to contain one or more applications, widgets, pieces of content, and other multimedia containers. The method further includes displaying on the display screen a plurality of images of minimized multimedia containers of the first level on a display screen and allowing user navigation therewith and responsive to a user selection of a first multimedia container of the multimedia containers of the first level, displaying on the display screen contents of the first multimedia container and allowing user navigation therewith while maintaining displayed on the display screen the plurality of images of minimized multimedia containers of the first level and allowing user navigation therewith.

In one embodiment, the contents of the first multimedia container are of the second level and are displayed beneath the plurality of images of minimized multimedia containers of the first level. The contents of the first multimedia container may comprises a second multimedia container and the method further includes responsive to a user selection of a minimized image of the second multimedia container, displaying on the display screen contents of the second multimedia container and allowing user navigation therewith while maintaining displayed on the display screen contents of the first multimedia container and allowing user navigation therewith while yet maintaining displayed on the display screen the plurality of images of minimized multimedia containers of the first level and allowing user navigation therewith. In one embodiment, the contents of the second multimedia container are of the third level and are displayed beneath the contents of the first multimedia container. In one exemplary embodiment, the minimized multimedia containers of the first level are operable for scrolling navigation (e.g., sideways). The method may further include responsive to a user selection of the first multimedia container of the multimedia containers of the first level, scaling a first image corresponding to the first multimedia container. The user selection of the first multimedia container of the multimedia containers of the first level comprises user selection an expansion icon corresponding to the first multimedia container of the multimedia containers.

In another embodiment, the present invention is implemented as a system for displaying a graphical user interface. The system includes a data store access module operable to access a data store corresponding to a plurality of multimedia containers. A first multimedia container of the plurality of multimedia containers comprises a second multimedia container. The first multimedia container is operable to comprise one or more applications, widgets, pieces of content and other multimedia containers. The system further includes a navigation module operable for navigation of a hierarchy of the plurality of multimedia containers and a display module operable to display a respective image for each of the plurality of multimedia containers. The respective image is operable to comprise a respective first image corresponding to an object of a respective multimedia container. In one embodiment, the navigation module is further operable for scrolling a plurality of images corresponding to a plurality of multimedia containers within the first multimedia container. Navigation module may be operable for invoking an expansion and collapse of the contents of the first multimedia container. The navigation module may be further operable for invoking display of a plurality of objects of a selected multimedia container. In one embodiment, the display module is operable to display a first plurality of images corresponding to a first plurality of multimedia containers of the first multimedia container and a second plurality of images corresponding to a second plurality of multimedia containers of the second multimedia container after display of a third plurality of images corresponding to a plurality of objects of a third multimedia container. The system may further include an input module operable to receive input to display a respective plurality of multimedia containers within the first multimedia container.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows an exemplary mobile device and an exemplary graphical user interface, in accordance with one embodiment of the present invention.

FIG. 2 shows an exemplary graphical user interface operable for navigation of multimedia containers, in accordance with one embodiment of the present invention.

FIG. 3 shows an exemplary graphical user interface operable for navigation of multimedia containers displaying a first portion of the multimedia containers of a first multimedia container and a second portion of the multimedia containers of a second multimedia container, in accordance with one embodiment of the present invention.

FIG. 4 shows an exemplary graphical user interface operable for navigation of multimedia containers displaying a respective portion of respective multimedia containers of each of a first multimedia container, a second multimedia container, and a third multimedia container, in accordance with one embodiment of the present invention.

FIG. 5 shows a flowchart of an exemplary computer controlled process for generating a graphical user interface for multimedia container hierarchy navigation, in accordance with one embodiment of the present invention.

FIG. 6 shows a block diagram of an exemplary computing system and corresponding modules, in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

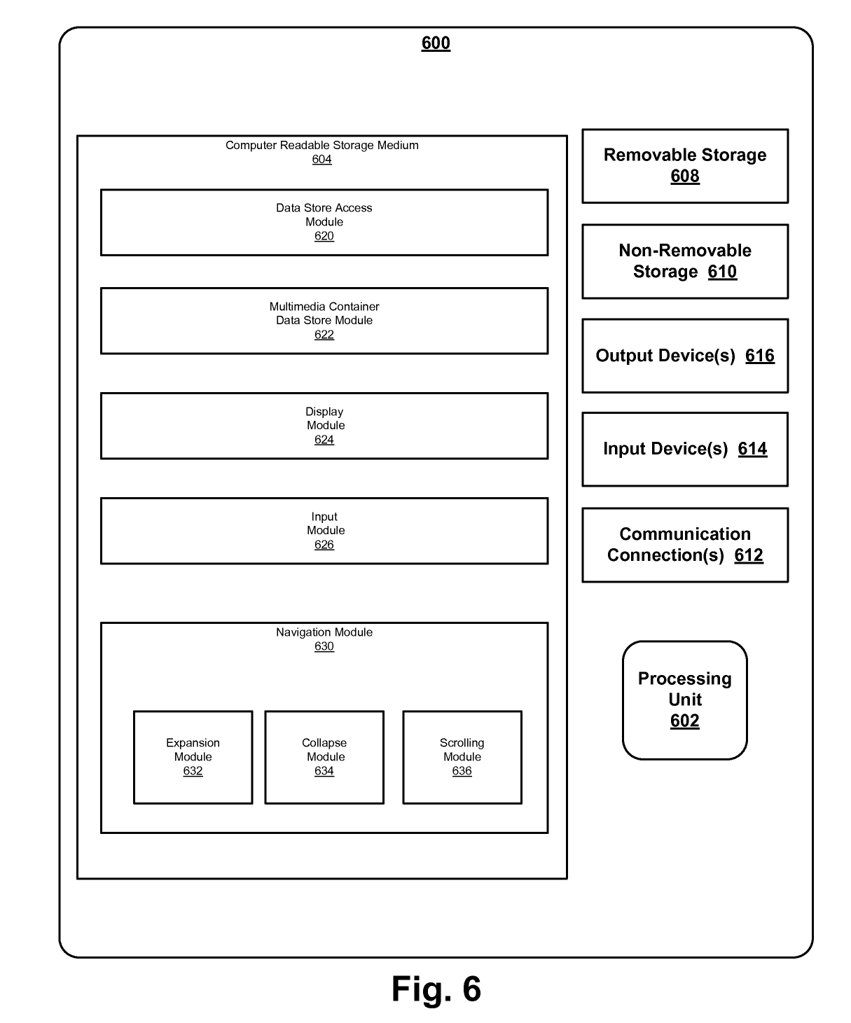

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of an integrated circuit (e.g., system 600 of FIG. 6), or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Systems and Methods for a Graphical User Interface for Hierarchy Navigation

Embodiments of the present invention allow user navigating through (e.g., up and down) multiple levels of a hierarchical structure of multimedia containers quickly and efficiently. Embodiments of the present invention further allow for the display of a visualization of the hierarchical structure created by the multimedia containers of a device. By displaying minimized views of multimedia containers of different hierarchical levels simultaneously with an open multimedia container, a user may thus display and access (e.g., random access) a desired multimedia container one or more levels away in the multimedia hierarchy without having to navigate individually through each multimedia container between an upper or lower level multimedia container and the desired multimedia container.

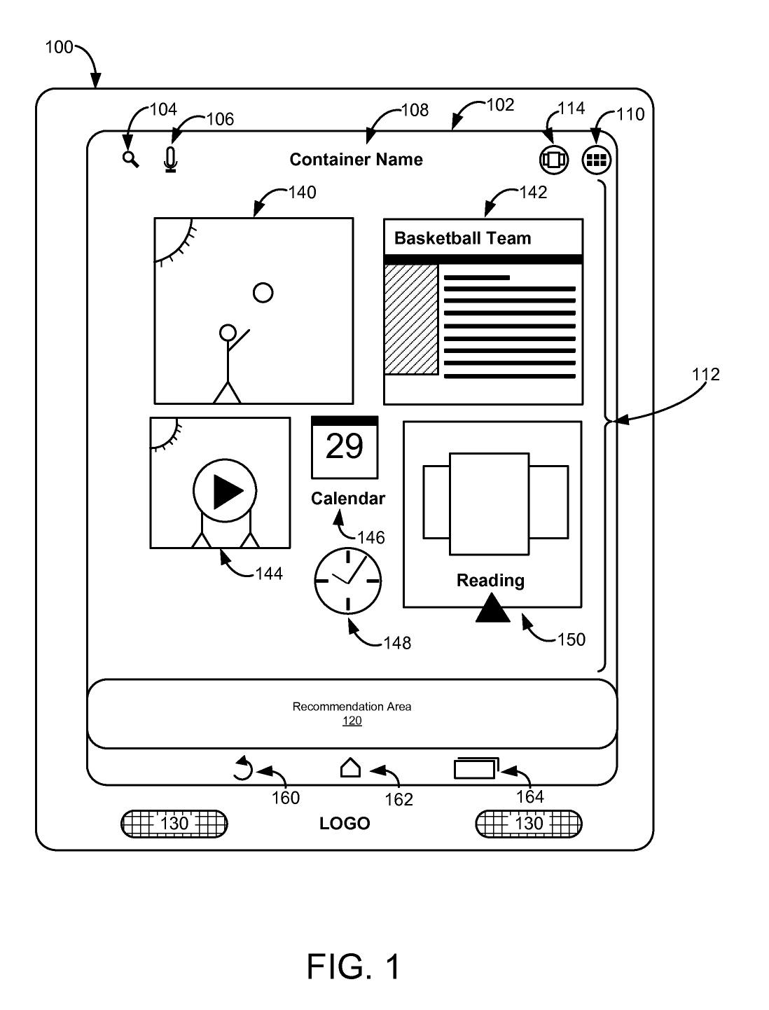

FIGS. 1-4 illustrate example components used by various embodiments of the present invention. Although specific components are disclosed in FIGS. 1-4, it should be appreciated that such components are exemplary. That is, embodiments of the present invention are well suited to having various other components or variations of the components recited in FIGS. 1-4. It is appreciated that the components in FIGS. 1-4 may operate with other components than those presented, and that not all of the components of FIGS. 1-4 may be required to achieve the goals of embodiments of the present invention.

FIG. 1 shows an exemplary mobile device and an exemplary multimedia container of an exemplary graphical user interface, in accordance with one embodiment of the present invention. FIG. 1 depicts an exemplary graphical user interface comprising an exemplary multimedia container displayed by a device (e.g., tablet computing device, mobile phone, smartphone, or the like).

In one embodiment, device 100 is a mobile computing device (e.g., tablet). Device 100 comprises speakers 130 and screen 102. In one embodiment, screen 102 is a touch sensitive (e.g., a capacitive touch screen) operable to receive input (e.g., from a user via one or more fingers) and display a graphical user interface. Speakers 130 are operable for output of audio during rendering of content (e.g., video, video games, animations, system functions, etc.).

Device 100 is operable to render a graphical user interface comprising a multimedia container. A multimedia container is a graphically navigable container that is operable to hold various objects of various media types (e.g., content), applications, and widgets. A multimedia container may include other multimedia containers therein which may further include respective content, applications, widgets, etc. In one exemplary embodiment, a multimedia container may include a song, an e-book, a video, a webpage, a contract, an email message, a text message, an application, etc. Multimedia containers display content in a pictorial manner thereby surfacing content for immediate consumption.

FIG. 1 depicts an exemplary graphical user interface rendered by device 100. The exemplary graphical user interface comprises search icon 104, voice recognition icon 106, container name 108, applications icon 110, object area 112, multimedia container navigation icon 114, recommendation area 120, and control icons 160-164. It is noted the objects within the multimedia container described below are exemplary and embodiments of the present invention can support more or less objects.

Object area 112 comprises pieces of content, application icons, and widgets of a multimedia container. In one exemplary embodiment, object area 112 includes image 140, website image 142, video image 144, application icon 146, widget 148, and multimedia container image 150. Pieces of content may be shown in pictorial form (e.g., without filenames). Objects in object area 112 can be resized by a user. Objects within object area 112 are selectable to launch a corresponding application or corresponding application for rendering content corresponding to the object in object area 112. Objects within object area 112 may be moved around (e.g., via dragging after selection via pressing and holding) or resized (e.g., via pressing and holding and manipulating a size control).

Image 140 is an image (e.g., scaled image, thumbnail, or the like) corresponding to an image that is stored on device 100. In one exemplary embodiment, image 140 is a scaled version of a child playing basketball (e.g., without a filename). Image 140 is selectable (e.g., via a touch or press) and is operable to launch an image viewing application to display an image corresponding to image 140 at full resolution. For example, a user can view image 140 at one resolution within the multimedia container and to see more detail a user can select image 140 to see the high resolution image that image 140 corresponds thereto.

Website image 142 corresponds to a rendering of a webpage (e.g., via a browser). In one exemplary embodiment, website image 142 is a scaled version of a rendering of the webpage according to a size specified corresponding to a multimedia container. In another embodiment, website image 142 is an image determined and selected from the content of the website corresponding to website image 142. Website image 142 is operable to be selected (e.g., via a touch or press) and is operable to launch a web browser to display the website corresponding to website image 142. Website image 142 and other objects within a multimedia container may be updated periodically (e.g., hourly, daily, and the like). In one embodiment, website image 142 and other objects are updated each time a user accesses the content corresponding to the object (e.g., the website corresponding to website image 142).

Video image 144 corresponds to a video (e.g., stored locally on device 100 or available over a communications network). In one embodiment, video image 144 is a scaled version (e.g., thumbnail) of a key frame of a video with an optional title. In one exemplary embodiment, video image 144 is a scaled version of a key frame of the video scaled according to a size specified corresponding to a multimedia container. Video image 144 is operable to be selected (e.g., via a touch or press) and is operable to launch a video application (e.g., for a video stored locally on device 100 or available for streaming) or launch a website with the video corresponding to video image 144.

Application icon 146 corresponds to an application and is selectable to launch the corresponding application. In one exemplary embodiment, application icon 146 corresponds to a calendar application and application icon 146 comprises an image of a calendar with the current date and text below with the name of the application.

Widget 148 is a widget and is operable to display live, auto-updating content. In one exemplary embodiment, widget 148 is a clock widget operable to display the current time. In one embodiment, widget 148 is operable to be selected (e.g., via touch or press) and upon selection launch a corresponding application (e.g., an clock application with alarm, timer, and stopwatch functionality).

Recommendation area 120 is operable to display recommendations of content (e.g., free or pay content) based on the objects of a multimedia container (e.g., based on the metadata associated with the objects of a multimedia container). In one embodiment, recommendation area 120 includes images representing content that is recommended based on the pieces of content (and/or applications and widgets) in the multimedia container.

Multimedia container image 150 is of a reading related multimedia media container which may include reading related objects (e.g., electronic book related application, widgets, and content). In one embodiment, display of multimedia container image 150 comprises images of objects within the multimedia container corresponding to multimedia image 150. In one exemplary embodiment, multimedia container image 150 includes an outerframe and triangle to indicate to a user that multimedia container image 150 corresponds to a multimedia container and selecting (e.g., via touch or press) launches display of the multimedia container. Multimedia container image 150 may be selected with a press and hold interaction and then dragged around to move multimedia container image 150.

Control icons 160-164 are operable for navigation of a plurality of multimedia containers and switching applications. Back control 160 is operable for navigation to a previous multimedia container. Home control 162 is operable for navigating to a home multimedia container. Recent applications button 164 is operable to invoke a function for changing applications.

Applications icon 110 is operable for invoking display of a graphical user interface for browsing application icons and launching corresponding applications. In one embodiment, the graphical user interface for browsing applications is organized into multiple pages of application icons.

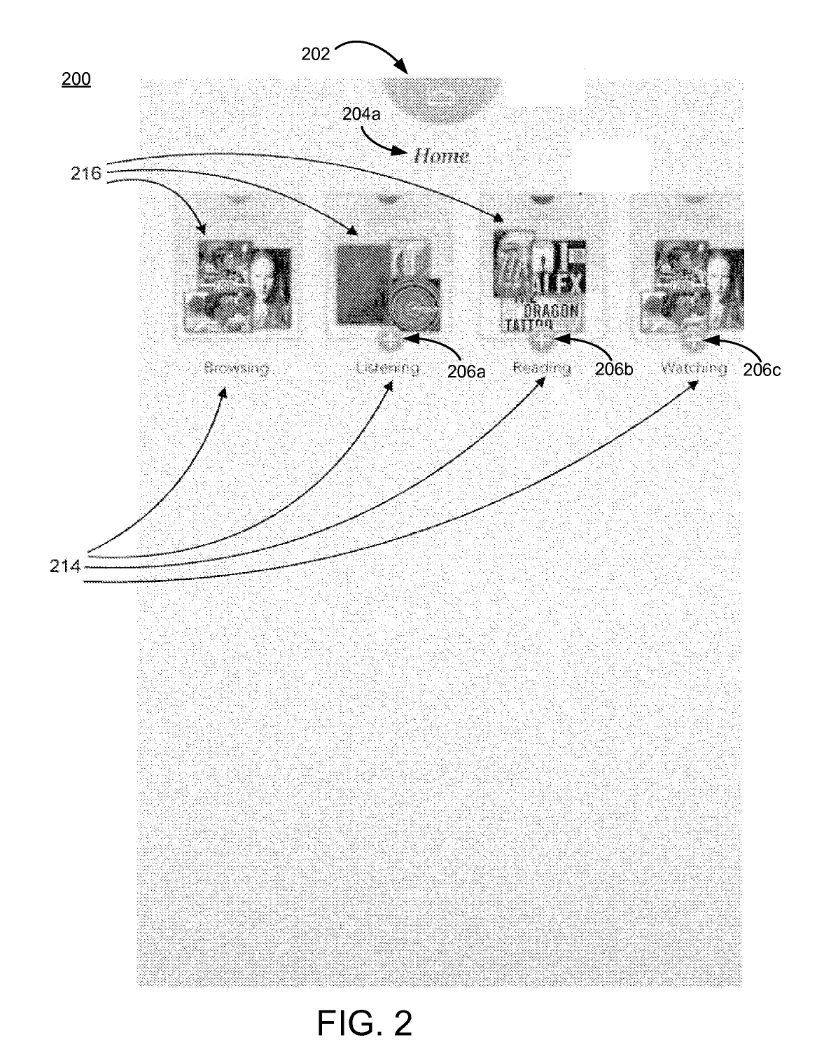

Multimedia container navigation icon 114 is operable for invoking display of a graphical user interface for navigation of a plurality of multimedia containers. In one embodiment, the multimedia containers are configured and displayed in a hierarchical manner (e.g., FIGS. 2-4). The graphical user interface of FIG. 1 may be displayed to show the contents of a multimedia container and displayed after a multimedia container is selected during hierarchical navigation of a plurality of multimedia containers. Embodiments of the present invention support display of the multimedia container hierarchy previously displayed prior to a user's selection and display of a multimedia container from the multimedia container hierarchy.

FIG. 2 shows an exemplary graphical user interface operable for navigation of multimedia containers, in accordance with one embodiment of the present invention. Exemplary graphical user interface 200 depicts a graphical user interface operable for navigation of a hierarchy of multimedia containers (e.g., multimedia containers having other multimedia containers inside or within). In other words, a multimedia container may be nested within another multimedia container. For example, a reading multimedia container may include a non-fiction multimedia container and a fiction multimedia container, etc.

Embodiments of the present invention support an object (e.g., applications, widgets, pieces of content, or other multimedia containers) being within multiple multimedia containers and thereby within multiple multimedia containers within the multimedia container hierarchy. For example, a multimedia container of audio books may be contained within a reading multimedia container and a listening multimedia container. It is noted that names of the multimedia containers are exemplary and any similarity in the names of the multimedia containers is not required. It is further noted that names are exemplary and other names may be used.

In one exemplary embodiment, the exemplary graphical user interfaces of FIGS. 2-4 are operable for navigation and display of multimedia containers where each multimedia container is operable to have one or more multimedia container therein. In other words, a multimedia container can be placed within another multimedia container. The multimedia containers may thus form a hierarchical or tree type structure with the top multimedia container being a top most node (e.g., primary multimedia container), multimedia containers within the top most node being secondary nodes, and multimedia containers within the secondary nodes being tertiary nodes, etc. Embodiments of the present invention are operable to support navigation of a multimedia container hierarchy of any number of levels. The exemplary graphical user interfaces of FIGS. 2-4 thereby allow efficient navigation of the multimedia container hierarchical tree structure.

Further, the exemplary graphical user interfaces of FIGS. 2-4 thereby allow opening of a selected multimedia container several levels down in the multimedia container tree without the user having to navigate through (e.g., individually open and view the content of the multimedia container) the multimedia containers in between the upper level multimedia containers and selected multimedia container. For example, exemplary graphical user interfaces of FIGS. 2-4 may provide a hierarchical view of the multimedia containers on device so that a user can quickly navigate between sibling multimedia containers or from a grandparent multimedia container to a child multimedia container without having to drill successively into each multimedia container between the grandparent multimedia container and the child multimedia container.

Exemplary graphical user interface 200 includes home icon 202, multimedia container label 204a, and minimized multimedia container images 214. Home icon 202 is operable for bringing a user back to a home screen including a graphical user interface displaying the contents of the home multimedia container (e.g., FIG. 1).

Multimedia container label 204a comprises an indicator of the multimedia container of which contents are currently being displayed. For example, multimedia container label 204a indicates that the “Home” multimedia container is currently being displayed.

In one embodiment, minimized multimedia container images 214 comprise labels of the respective names of each corresponding multimedia container. As shown in exemplary graphical user interface 200, the Home multimedia container includes a Browsing multimedia container, a Listening multimedia container, a Reading multimedia container, and a Watching multimedia container. Minimized multimedia container images 214 may further include images 216 of the objects (e.g., applications, widgets, pieces of content, and other multimedia containers) within the respective multimedia container. Images 216 may provide visual queues as to the contents of a multimedia container thereby assisting navigation. For example, the image for the Reading multimedia container may include images (e.g., thumbnails) of the books within the Reading multimedia container. In various embodiments, images 216 may be automatically generated based on the contents of the multimedia container or may be selected by a user. For example, a user may choose a picture of a book for the Reading multimedia container.

Minimized multimedia container images 214 may further include expand icons 206a-c. Each of expand icons 206a-c may be plus (+) sign, other symbol, text, etc. In one embodiment, expand icons 206a-c are displayed for multimedia containers that include other multimedia containers therein. For example, the Listening, Reading, and Watching multimedia containers include other multimedia containers therein and the Browsing multimedia container does not include other multimedia containers.

Embodiments of the present invention further allow navigation of the multimedia containers within a selected multimedia container via scrolling left and right or up and down. For example, a user may scroll left or right to view the multimedia containers within the Home multimedia container that are to the left of the Browsing multimedia container and to the right of the Watching multimedia container. Embodiments of the present invention further support expanding the scrollable area corresponding to a multimedia container as objects (e.g., applications, widgets, pieces of content, and other multimedia containers) are added to a multimedia container.

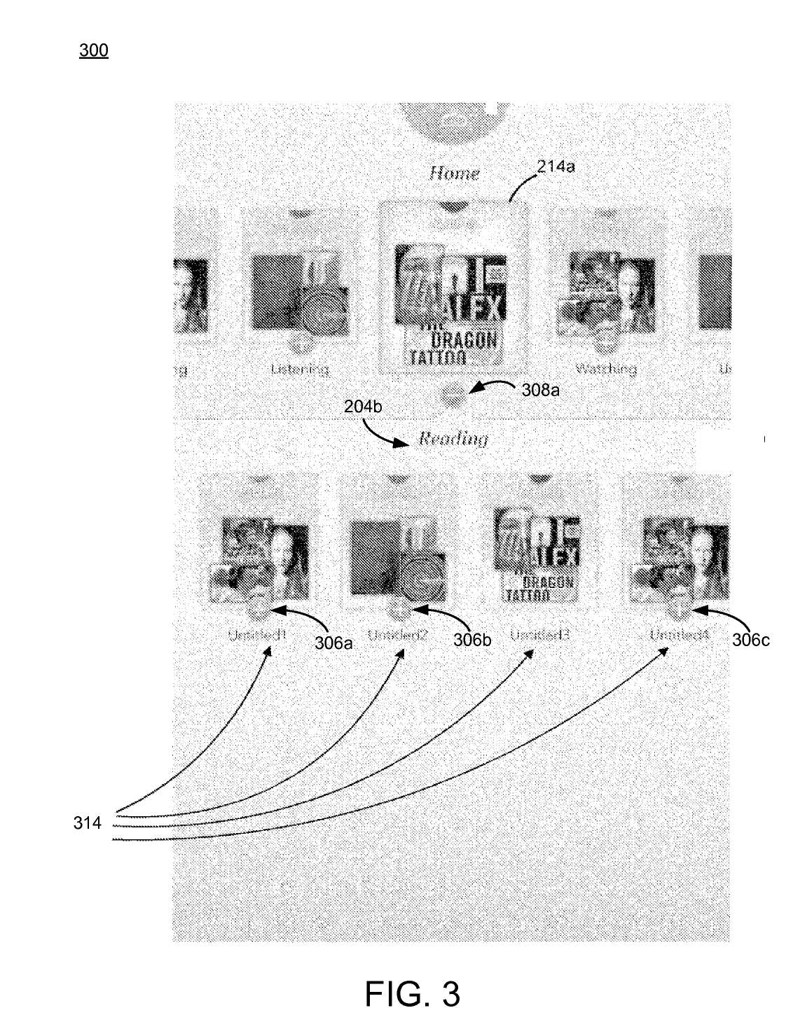

FIG. 3 shows an exemplary graphical user interface operable for navigation of multimedia containers displaying a first portion of the multimedia containers of a first multimedia container and a second portion of the multimedia containers of a second multimedia container, in accordance with one embodiment of the present invention. Exemplary graphical user interface 300 depicts a graphical user interface after a multimedia container has been expanded (e.g., to show another level of the multimedia container hierarchy and show the multimedia containers and/or objects within the expanded multimedia container). In one embodiment, exemplary graphical user interface 300 includes elements similar to exemplary graphical user interface 200.

Embodiments of the present invention are operable to display the contents (e.g., multimedia containers) within an expanded multimedia container in a row below or column next to the expanded multimedia container. For example, when a multimedia container, corresponding to minimized multimedia image 214a, is expanded the contents (e.g., minimized multimedia container images) 314 of multimedia container are displayed below minimized multimedia container image 214a. Embodiments of the present invention further allow navigation of the multimedia containers within a selected multimedia container via scrolling left and right or up and down. In one embodiment, the contents of a multimedia container may be displayed in a full-screen mode such that when contents of the multimedia container are displayed without the display of a parent multimedia container.

For example, exemplary graphical user interface 300 depicts the contents or multimedia container images 314 (e.g., multimedia containers with the Reading multimedia container) of the Reading multimedia container 214a within a region of a screen or display and at the same time in other regions of the screen, the contents of the upper level Home multimedia container are displayed. Exemplary graphical user interface 300 further displays minimized multimedia containers (e.g., the Listening and Watching multimedia containers) along with lower level multimedia containers (e.g., the Untitled1, Untitled2, Untitled3, and Untitled 4 multimedia containers of the Reading multimedia container).

Minimized multimedia container image 214a corresponds to the reading multimedia container that has been expanded or opened (e.g., via expand icon 206b). In one embodiment, minimized multimedia container image 214a is scaled or enlarged to visually indicate that the corresponding Reading multimedia container was expanded. The images representing other multimedia containers 314 (e.g., sibling multimedia containers) may further be shifted (e.g., left or right) as minimized multimedia container image 214a is enlarged. For example, the image corresponding to the Browsing multimedia container is partially shown in exemplary graphical user interface 300. In one embodiment, if expand icon 206a (of the Listening multimedia container) or expand 206c (of the Watching multimedia container) is selected the Listening multimedia container or the Watching multimedia container may be expanded and the contents of the respective multimedia container displayed.

Exemplary graphical user interface 300 includes multimedia container label 204b, collapse icon 308a, and multimedia container images 314. Multimedia container label 204b comprises an indicator of the multimedia container of which contents are currently being displayed (e.g., after expansion of the contents of the multimedia container). For example, multimedia container label 204a indicates that the contents of Reading multimedia container are currently being displayed. Embodiments of the present invention may further support the display of the contents of a multimedia container including objects (e.g., applications, widgets, and pieces of content) and other multimedia containers.

Collapse or minimize icon 308a is operable to indicate that a multimedia container has been opened and further is operable for collapsing, minimizing, or closing the display of the contents of a multimedia container. For example, if a user wishes to view the contents of another multimedia container, he or she may collapse the expanded view of the Reading multimedia container which hides or removes multimedia container images 314 from graphical user interface 300 thereby displaying exemplary graphical user interface 200. The collapse icon may be a minus (−) sign, other symbol, text, etc. In one exemplary embodiment, upon collapsing a multimedia container, the corresponding multimedia container image (e.g., minimized Reading multimedia container image 214a) is reduced in size to the size of other multimedia container images (e.g., to the size of the images corresponding to the Watching and Listening multimedia containers). In one embodiment, expand icon 206b may be replaced with the collapse icon 308a (e.g., along with the display of the contents of the Reading multimedia container) in response to selection of expand icon 206b.

In one embodiment, multimedia container images 314 comprise labels of the name of the multimedia container. As shown in exemplary graphical user interface 300, the Reading multimedia container includes an “Untitled1” multimedia container, an “Untitled2” multimedia container, an “Untitled3” multimedia container, and an “Untitled4” multimedia container. Multimedia container images 314 may further include images of the objects (e.g., applications, widgets, pieces of content, and other multimedia containers) within the respective multimedia container. For example, the image for the Untitled3 multimedia container includes images of the books within the Untitled3 multimedia container.

Multimedia container images 314 may further include expand icons 306a-c. In one embodiment, expand icons 306a-c are displayed for multimedia containers that include other multimedia containers. For example, the Untitled1, Untitled2, and Untitled4 multimedia containers include other multimedia containers therein while the Untitled3 multimedia container does not include other multimedia containers.

A user may thus select a multimedia container of open multimedia container 214a or select one of the minimized multimedia containers of the level above (e.g., the Listening multimedia container or the Watching multimedia container) thereby facilitating navigation through the multimedia containers (e.g., and associated hierarchy).

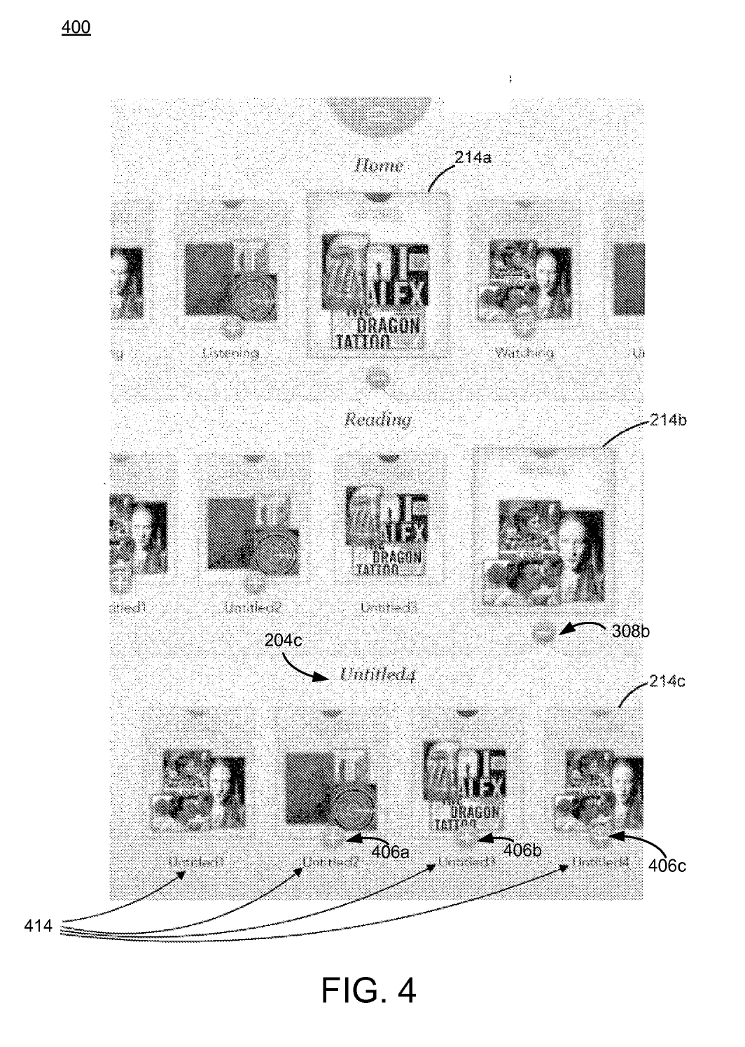

FIG. 4 shows an exemplary graphical user interface operable for efficient navigation of multimedia containers displaying a respective portion of respective multimedia containers of each of a first multimedia container, a second multimedia container, and a third multimedia container, in accordance with one embodiment of the present invention. In one embodiment, exemplary graphical user interface 400 includes elements similar to exemplary graphical user interface 300.

In one embodiment, exemplary graphical user interface 400 depicts graphical user interface 300 after another multimedia container 214b has been expanded (e.g., to show another level of the multimedia container hierarchy and show the multimedia containers and/or objects within contents 414). For example, exemplary graphical user interface 400 depicts the display of the multimedia containers of the Untitled4 multimedia container which is within the Reading multimedia container, which is within the Home multimedia container.

Minimized multimedia container image 214b corresponds to the Untitled4 multimedia container that has been expanded or opened (e.g., via expand icon 306c to present contents thereof 414). In one embodiment, minimized multimedia container image 214b is scaled or enlarged to visually indicate that the corresponding Untitled4 multimedia container was expanded. The images representing the multimedia containers may further be shifted (e.g., left or right) as minimized multimedia container image 214b is enlarged. For example, the image corresponding to the Untitled1 multimedia container is partially shown in exemplary graphical user interface 400.

Exemplary graphical user interface 400 includes multimedia container label 204c, collapse icon 308b, and multimedia container images or contents 414. Multimedia container label 204c comprises an indicator of the multimedia container of which contents are currently being displayed (e.g., after expansion of the contents of the multimedia container). For example, multimedia container label 204b indicates that the contents of Untitled4 multimedia container are currently being displayed. Embodiments of the present invention may further support the display of the contents of a multimedia container including objects (e.g., application, widgets, and pieces of content) and other multimedia containers.

Collapse icon 308b is operable to indicate that a multimedia container has been opened and further is operable for collapsing or closing the display of the contents of a multimedia container. For example, if a user wishes to view the contents of another multimedia container, he or she may collapse the expanded view of the Untitled4 multimedia container which hides or removes multimedia container images 414 from graphical user interface 400. In one exemplary embodiment, upon collapsing a multimedia container, the corresponding multimedia container image (e.g., minimized Untitled4 multimedia container image 214b) is reduced in size to the size of other multimedia container images (e.g., to the size of the images corresponding to the Untitled2 and Untitled3 multimedia containers). In one embodiment, expand icon 306b may be replaced with the collapse icon 308b (e.g., along with the display of the contents of the Untitled4 multimedia container) in response to selection of expand icon 306b.

In one embodiment, multimedia container images 414 comprise labels of the name of the multimedia container. As shown in exemplary graphical user interface 400, the Untitled4 multimedia container includes an “Untitled1” multimedia container, an “Untitled2” multimedia container, an “Untitled3” multimedia container, and an “Untitled4” multimedia container. Multimedia container images 414 may further include images of the objects (e.g., applications, widgets, pieces of content, and other multimedia containers) within the respective multimedia container. For example, the image for the Untitled3 multimedia container includes images of the books within the Untitled3 multimedia container.

Multimedia container images 414 may further include expand icons 406a-c. In one embodiment, expand icons 406a-c are displayed for multimedia containers that include other multimedia containers. For example, the Untitled2, Untitled3, and Untitled4 multimedia containers include other multimedia containers therein while the Untitled1 multimedia container does not include other multimedia containers.

In one embodiment, the Reading multimedia container is a primary multimedia container, the Untitled4 multimedia container (of the Reading multimedia container) is a secondary multimedia container, and the Untitled4 multimedia container (of the Untitled4 multimedia container) is a tertiary multimedia container.

Embodiments of the present invention support vertically scrolling if the multimedia container hierarchy exceeds the size of the screen or display of a device (e.g., device 100). Embodiments of the present invention may further support scaling of each images of the multimedia container hierarchy (e.g., images 214, 314, and 414) (and associated graphical elements) if the multimedia container hierarchy exceeds or is near to exceeding the size of the screen or display of a device.

A user may thus select a multimedia container or item of contents 414 or select a multimedia container of the second level (e.g., contents 314) or select a multimedia container of the first level (e.g., contents 214) each at the same navigation stage because each of the multimedia containers or items are displayed in graphical user interface 400 simultaneously.

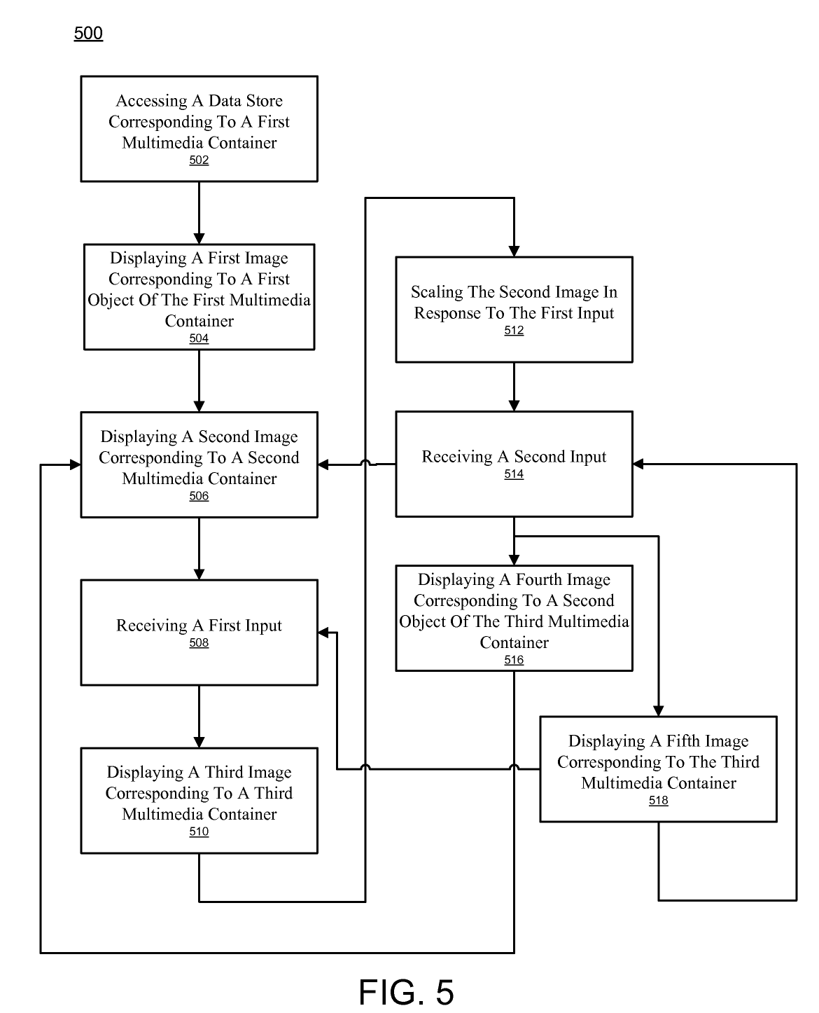

With reference to FIG. 5, flowchart 500 illustrates example functions used by various embodiments of the present invention for displaying graphical user interfaces. Although specific function blocks (“blocks”) are disclosed in flowchart 500, such steps are examples. That is, embodiments are well suited to performing various other blocks or variations of the blocks recited in flowchart 500. It is appreciated that the blocks in flowchart 500 may be performed in an order different than presented, and that not all of the blocks in flowchart 500 may be performed.

FIG. 5 shows a flowchart of an exemplary computer controlled process for generating a graphical user interface for multimedia container hierarchy navigation, in accordance with one embodiment of the present invention. In one exemplary embodiment, FIG. 5 depicts a process 500 of rendering a graphical user interface for navigating a hierarchy of multimedia containers. Process 500 may further include selecting a multimedia container to be displayed (e.g., selected via selection of an image corresponding to a multimedia container) or scrolling through the contents a multimedia container in the multimedia hierarchy.

At block 502, a data store corresponding to a first multimedia container is accessed. In one embodiment, a data store, within a mobile device, corresponding to a first multimedia container is accessed. The data store may correspond to one or more multimedia containers. The multimedia container is operable to comprise one or more objects (or have pointers thereto) including one or more applications, widgets, and pieces of content. The first multimedia container may comprise one or more multimedia containers (e.g., a second multimedia container).

At block 504, a first image corresponding to a first object of the first multimedia container is displayed. In one exemplary embodiment, the objects (e.g., applications, widgets, and pieces of content) are displayed in the multimedia container hierarchy.

At block 506, a second image corresponding to a second multimedia container is displayed. In one exemplary embodiment, the second image of a multimedia container within a home multimedia container (e.g., FIG. 2). In one embodiment, a first subset of a first plurality of respective images each corresponding to a respective object of a first multimedia container is displayed on a mobile device. The second multimedia container may be operable to comprise one or more applications, widgets, pieces of content and other multimedia containers.

At block 508, a first input is received. The first input may be in the form of a finger press on a touch screen, or activation of a pointing device on an image corresponding to an object and/or multimedia container. The first input may select an image (e.g., expand icon 206a, 306a, 406a) to invoke expansion of a multimedia container.

At block 510, a third image corresponding to a third multimedia container is displayed. In one exemplary embodiment, the third image corresponds to a third multimedia container within the second multimedia container that has been expanded during multimedia hierarchy display. The second and third images may thus be displayed simultaneously. The second and third images may be displayed in a hierarchical structure. For example, the second image may be displayed on a first row and the third image may be displayed on a second row that is below the first row (e.g., FIG. 3).

In one embodiment, a second subset of a second plurality of respective images each corresponding to a respective object of a second multimedia container is displayed (e.g., when a multimedia container is displayed). The first multimedia container may comprise the second multimedia container. The first subset of the plurality of respective images and the second subset of the plurality of respective images may be displayed in a hierarchy. In one exemplary embodiment, the first subset of a first plurality of images corresponding to the first multimedia container and the displaying of the second subset of the second plurality of respective images corresponding to the second multimedia container is simultaneous.

At block 512, the second image is scaled in response to the first input. In one exemplary embodiment, upon expanding a multimedia container to display the contents thereof, the second image corresponding to the second multimedia container is scaled (e.g., enlarged) to indicate the contents (e.g., multimedia containers and/or objects within the second multimedia container) of the expanded multimedia container are being displayed (e.g., minimized multimedia container image 214a).

At block 514, a second input is received. In one embodiment, the second input is for scrolling (e.g., a swiping motion) through the multimedia containers (and/or objects) within a multimedia container and in response block 518 is performed. In another embodiment, the second input is a selection of a multimedia container and in response, block 516 is performed.

The second input may further be input to expand or display the multimedia containers within a multimedia container and block 506 may be performed. In one embodiment, in response to the second input, a third subset of the third plurality of respective images each corresponding to a respective object of the third multimedia container is displayed. The second multimedia container may comprise the third multimedia container.

At block 516, a fourth image corresponding to a second object of the third multimedia container is displayed. In one embodiment, the fourth image is displayed during the displaying of a multimedia container (e.g., FIG. 1). In one exemplary embodiment, in response to selection of a first image of the second subset of the second plurality of images, a third subset of a third plurality of images corresponding to a plurality of objects (e.g., the multimedia containers, applications, widgets, and pieces of content) of the second multimedia container is displayed (e.g., FIG. 1). Block 506 may be performed if input is received to invoke multimedia container hierarchy navigation (e.g., via multimedia hierarchy navigation icon 114).

In one exemplary embodiment, multimedia container hierarchy navigation may be invoked after display of the contents of a multimedia container selected from the multimedia container hierarchy (e.g., FIGS. 2-4) and the displaying of the first subset of the first plurality of respective images corresponding to the first multimedia container is after the displaying of the third plurality of images. A user may thus navigate within the multimedia hierarchy, select a multimedia container to be displayed (e.g., FIG. 1) and then return to the multimedia hierarchy navigation. Upon entering the multimedia container hierarchy, the user may be presented with the multimedia hierarchy as displayed prior (e.g., FIG. 4) to selection the multimedia container.

At block 518, a fifth image corresponding to third multimedia container is displayed. In one embodiment, the fifth image comprises an image of an object within the third multimedia container and displayed as the contents of a multimedia container in the multimedia hierarchy (e.g., via scrolling). Block 508 may then be performed. In another embodiment, in response to the second input, displaying a second subset of the first plurality of respective images each corresponding to the respective object of the first multimedia container.

In one exemplary embodiment, process 500 may include accessing a data store comprising a hierarchical ordering of multimedia containers comprising a first level, a second level and a third level of the hierarchical ordering. Each multimedia container is operable to contain one or more applications, widgets, pieces of content, and other multimedia containers. Process 500 may further include displaying on the display screen a plurality of images of minimized multimedia containers of the first level on a display screen and allowing user navigation therewith and responsive to a user selection of a first multimedia container of the multimedia containers of the first level, displaying on the display screen contents of the first multimedia container and allowing user navigation therewith while maintaining displayed on the display screen the plurality of images of minimized multimedia containers of the first level and allowing user navigation therewith.

In one embodiment, the contents of the first multimedia container are of the second level and are displayed beneath the plurality of images of minimized multimedia containers of the first level. The contents of the first multimedia container may comprises a second multimedia container and process 500 further comprises responsive to a user selection of a minimized image of the second multimedia container, displaying on the display screen contents of the second multimedia container and allowing user navigation therewith while maintaining displayed on the display screen contents of the first multimedia container and allowing user navigation therewith while yet maintaining displayed on the display screen the plurality of images of minimized multimedia containers of the first level and allowing user navigation therewith. In one embodiment, the contents of the second multimedia container are of the third level and are displayed beneath the contents of the first multimedia container.

In one exemplary embodiment, the minimized multimedia containers of the first level are operable for scrolling navigation (e.g., sideways). Process 500 may further include responsive to a user selection of the first multimedia container of the multimedia containers of the first level, scaling a first image corresponding to the first multimedia container. The user selection of the first multimedia container of the multimedia containers of the first level comprises user selection an expansion icon corresponding to the first multimedia container of the multimedia containers.

FIG. 6 illustrates exemplary components used by various embodiments of the present invention. Although specific components are disclosed in computing system environment 600, it should be appreciated that such components are exemplary. That is, embodiments of the present invention are well suited to having various other components or variations of the components recited in computing system environment 600. It is appreciated that the components in computing system environment 600 may operate with other components than those presented, and that not all of the components of system 600 may be required to achieve the goals of computing system environment 600.

FIG. 6 shows a block diagram of an exemplary computer system and corresponding modules, in accordance with one embodiment of the present invention. With reference to FIG. 6, an exemplary system module for implementing embodiments includes a general purpose computing system environment, such as computing system environment 600. Computing system environment 600 may include, but is not limited to, servers, desktop computers, laptops, tablet PCs, tablet computing devices, mobile devices, and smartphones. In its most basic configuration, computing system environment 600 typically includes at least one processing unit 602 and computer readable storage medium 604. Depending on the exact configuration and type of computing system environment, computer readable storage medium 604 may be volatile (such as RAM), non-volatile (such as ROM, flash memory, etc.) or some combination of the two. Portions of computer readable storage medium 604 when executed facilitate efficient execution of memory operations or requests for groups of threads. Computing system environment 600 may further include a power source (e.g., battery) (not shown) operable to allow computing system environment 600 to be movable and mobile while operating.

Additionally, computing system environment 600 may also have additional features/functionality. For example, computing system environment 600 may also include additional storage (removable and/or non-removable) including, but not limited to, magnetic or optical disks or tape. Such additional storage is illustrated in FIG. 10 by removable storage 608 and non-removable storage 610. Computer storage media includes volatile and nonvolatile, removable and non-removable media implemented in any method or technology for storage of information such as computer readable instructions, data structures, program modules or other data. Computer readable medium 604, removable storage 608 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 600. Any such computer storage media may be part of computing system environment 600.

Computing system environment 600 may also contain communications connection(s) 612 that allow it to communicate with other devices. Communications connection(s) 612 is an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

Communications connection(s) 612 may allow computing system environment 600 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), Near Field Communication (NFC), Code Division Multiple Access (CDMA), Global System for Mobile Communications (GSM), Long-term Evolution (LTE), Worldwide Interoperability for Microwave Access (WiMax), wide area networks (WAN) such as the internet, serial, and universal serial bus (USB). It is appreciated the various network types that communication connection(s) 612 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 600 may also have input device(s) 614 such as a touch screen (e.g., capacitive touch screen), keyboard, mouse, pen, voice input device, touch input device, remote control, camera, etc. Output device(s) 616 such as a display (e.g., touch screen), speakers, etc. may also be included. All these devices are well known in the art and are not discussed at length.

In one embodiment, computer readable storage medium 604 includes data store access module 620, multimedia container data store module 622, display module 624, input module 626, and navigation module 630.

Data store access 620 module is operable to access multimedia container data store module 622 (e.g., based on a request from input module 626 and/or navigation module 630). Multimedia container data store module 622 is operable to store data corresponding to a plurality of multimedia containers (e.g., multimedia containers operable to form a multimedia container hierarchy), as described herein. In one exemplary embodiment, a first multimedia container of the plurality of multimedia containers comprises a second multimedia container. The first and second multimedia containers may be operable to comprise one or more applications, widgets, pieces of content and other multimedia containers.

Display module 624 is operable to display a respective image for each of the plurality of multimedia containers, as described herein. In one exemplary embodiment, each respective image is operable to comprise a respective first image (e.g., images 216) corresponding to an object of a respective multimedia container.

Input module 626 is operable to receive input to display a respective plurality of multimedia containers within a multimedia container (e.g., multimedia expansion). Input module 626 may receive input to display a multimedia container (e.g., FIG. 1) or input for scrolling through the contents of a multimedia container during display of a multimedia hierarchy.

Navigation module 630 is operable for navigation of a hierarchy of the plurality of multimedia containers. Navigation module 630 may be further operable for invoking an expansion and collapse of the contents of a multimedia container, as described herein. Navigation module 630 may be further operable for invoking display of a plurality of objects of a selected multimedia container, as described herein. For example, navigation module 630 may allow selection of a multimedia container for display (e.g., FIG. 1).

In one embodiment, navigation module 630 includes expansion module 632, collapse module 634, and scrolling module 636. Expansion module 632 is operable for invoking (e.g., via expansion icon 206a) display of the contents of a multimedia container, as described herein. Collapse module 634 is operable invoke (e.g., via collapse icon 308a) collapsing or minimizing the contents of a multimedia container, as described herein.

Scrolling module 636 is operable for scrolling a plurality of images corresponding to a plurality of multimedia containers within a first multimedia container (e.g., scrolling left and/or right within the contents of a multimedia container displayed in the multimedia container hierarchy).

Display module 624 is operable to display a multimedia container hierarchy (e.g., FIGS. 2-4) and images corresponding to the multimedia containers therein, as described herein. In one embodiment, display module 624 is operable to display a first plurality of images corresponding to a first plurality of multimedia containers of the first multimedia container and a second plurality of images corresponding to a second plurality of multimedia containers of the second multimedia container after display of a third plurality of images corresponding to a plurality of objects of a third multimedia container.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for rendering a graphical user interface, said method comprising:
accessing, within a mobile device, a first data store corresponding to a first multimedia container, wherein said first multimedia container is operable to comprise one or more applications, widgets, and pieces of content, and wherein said first multimedia container comprises a second multimedia container;
displaying a first image corresponding to said second multimedia container;
receiving a first input; and
displaying a second image corresponding to a third multimedia container, wherein said second multimedia container comprises said third multimedia container.

2. The method as described in claim 1, wherein said first image and said second image are displayed simultaneously.

3. The method as described in claim 1, wherein said first image and said second image are displayed in a hierarchical structure.

4. The method as described in claim 1, further comprising:
receiving a second input; and
in response to said second input, displaying a first object of said second multimedia container.

5. The method as described in claim 1, wherein said first image comprises a third image corresponding to a first object of said second multimedia container.

6. The method as described in claim 1, further comprising:
scaling said first image in response to said first input.

7. The method as described in claim 1, further comprising:
displaying a third image corresponding to a first object of said first multimedia container.

8. A method of rendering a graphical user interface on a display screen, said method comprising:
accessing a data store comprising a hierarchical ordering of multimedia containers comprising a first level, a second level and a third level of said hierarchical ordering, wherein each multimedia container is operable to contain one or more applications, widgets, pieces of content, and other multimedia containers;
displaying on said display screen a plurality of images of minimized multimedia containers of said first level on a display screen and allowing user navigation therewith; and
responsive to a user selection of a first multimedia container of said multimedia containers of said first level, displaying on said display screen contents of said first multimedia container and allowing user navigation therewith while maintaining displayed on said display screen said plurality of images of minimized multimedia containers of said first level and allowing user navigation therewith.

9. A method as described in claim 8 wherein said contents of said first multimedia container are of said second level and are displayed beneath said plurality of images of minimized multimedia containers of said first level.

10. A method as described in claim 8 wherein said contents of said first multimedia container comprises a second multimedia container and further comprising responsive to a user selection of a minimized image of said second multimedia container, displaying on said display screen contents of said second multimedia container and allowing user navigation therewith while maintaining displayed on said display screen contents of said first multimedia container and allowing user navigation therewith while yet maintaining displayed on said display screen said plurality of images of minimized multimedia containers of said first level and allowing user navigation therewith.

11. A method as described in claim 10 wherein said contents of said second multimedia container are of said third level and are displayed beneath said contents of said first multimedia container.

12. The method as described in claim 8 wherein said minimized multimedia containers of said first level are operable for scrolling navigation.

13. The method as described in claim 8 further comprising responsive to a user selection of said first multimedia container of said multimedia containers of said first level, scaling a first image corresponding to said first multimedia container.

14. The method as described in claim 8 wherein said user selection of said first multimedia container of said multimedia containers of said first level comprises user selection an expansion icon corresponding to said first multimedia container of said multimedia containers.

15. A system for displaying a graphical user interface, said system comprising:
a data store access module operable to access a data store corresponding to a plurality of multimedia containers, wherein a first multimedia container of said plurality of multimedia containers comprises a second multimedia container, and wherein said first multimedia container is operable to comprise one or more applications, widgets, pieces of content and other multimedia containers;
a navigation module operable for navigation of a hierarchy of said plurality of multimedia containers; and
a display module operable to display a respective image for each of said plurality of multimedia containers, wherein said respective image is operable to comprise a respective first image corresponding to an object of a respective multimedia container.

16. The system as described in claim 15, further comprising:
an input module operable to receive input to display a respective plurality of multimedia containers within said first multimedia container.

17. The system as described in claim 15, wherein said navigation module is further operable for scrolling a plurality of images corresponding to a plurality of multimedia containers within said first multimedia container.

18. The system as described in claim 15, wherein said navigation module is further operable for invoking display of a plurality of objects of a selected multimedia container.

19. The system as described in claim 15, wherein said navigation module is operable for invoking an expansion and collapse of the contents of said first multimedia container.

20. The system as described in claim 15, wherein said display module is operable to display a first plurality of images corresponding to a first plurality of multimedia containers of said first multimedia container and a second plurality of images corresponding to a second plurality of multimedia containers of said second multimedia container after display of a third plurality of images corresponding to a plurality of objects of a third multimedia container.
